(19) United States
(12) Patent Application Publication
(10) Pub. No.: US 2015/0161921 A1
(43) Pub. Date: Jun. 11, 2015

(54) DISPLAY UNIT

(71) Applicant: The Cardboard Box Company Limited, Accrington (GB)

(72) Inventors: Thomas Penman, Accrington (GB); Lee Mansfield, Accrington (GB)

(21) Appl. No.: 14/565,721

(22) Filed: Dec. 10, 2014

Related U.S. Application Data
(60) Provisional application No. 61/954,802, filed on Mar. 18, 2014.

(30) Foreign Application Priority Data
Dec. 10, 2013 (GB) 1321833.4
Jan. 16, 2014 (GB) 1400714.0

(51) Int. Cl. G09F 13/20; G09F 13/06; G09F 13/04

(52) U.S. Cl. CPC G09F 13/20; G09F 13/0413; G09F 13/06; G09F 2013/222

(57) ABSTRACT

A display unit comprises a display stand—preferably of cardboard—having at least one marking (t/g) comprised of a material that fluoresces when irradiated with ultra-violet light, and an electrically operated source of ultra-violet light for irradiating said marking (t/g). The marking (t/g) may be on a surface of an open-fronted compartment of the unit and the ultra-violet light source may be partially shielded from extraneous light by a frontal lip of compartment. The unit may further comprise a box-like construction with a face having cut-outs defining stylised lettering. Behind the face is a fluorescent material visible through the cut-outs and at least one source of ultra-violet light, operation of which gives the appearance of the stylised letters being at the front of, and illuminated by, a lit chamber.

The present invention relates to a display unit intended particularly, but not necessarily exclusively, for displaying or promoting products or services that are for sale, on offer or otherwise available in a sales outlet (e.g. items that are for sale or on offer in a sales outlet (e.g. a store). The display unit may be one that is intended to support products that may be selected from the display unit by a consumer. Alternatively, the display unit may be a promotional unit which is not intended for supporting products but rather for advertising products or services.

Display units are used extensively in retail stores (e.g. supermarkets) and other outlets for displaying merchandise. Such display units may, for example, be provided at any location in a store, e.g. near a payment point in the store or along or at the end of an aisle in a supermarket. Such display units may be constructed of cardboard and are generally provided with text, numbers, graphics and/or other indicia (e.g. Trade Marks, logos, descriptive matter, price etc.) or other markings relevant to the product being displayed.

It is an object of the present invention to provide a display unit, which, in use, is of enhanced appearance as compared to prior display units.

According to the present invention there is provided a display unit comprising a display stand having at least one marking comprised of a material that fluoresces when irradiated with ultra-violet light, and an electrically operated source of ultra-violet light for irradiating said marking to cause fluorescence thereof.

Enhanced appearance is provided by virtue of the display stand having at least one marking which is comprised of a material that fluoresces in ultra-violet light. The fluorescent effect is achieved by virtue of illuminating the fluorescent marking with an electrically operated source of ultra-violet light, which is for preference provided on the display stand itself. Preferably an ultra-violet light source provided on the display stand is partially shielded from extraneous light so as to enhance the fluorescent effect obtained.

The display stand is preferably conducted of cardboard (e.g. corrugated cardboard) or other fibrous cellulosic board material. The display stand may be of demountable construction.

Most preferably, the electrically operated ultra-violet light source comprises at least one Light Emitting Diode (LED) having an ultra-violet component in its emission spectrum. Most conveniently, a plurality of electrically connected LED's are provided, and these may conveniently be in the form of at least one strip.

The fluorescent material is most preferably provided by a fluorescent ink, e.g. a water soluble fluorescent ink. The marking may comprise a plurality of fluorescent inks of different colours.

In a first embodiment, the fluorescent marking may, for example, be a printed marking provided on a surface (usually exterior surface) of the display stand. The printed marking may, in some embodiments, be of a plain colour. Alternatively a printed marking may comprise a textual, numeric, graphic and/or other indicative marking comprised of a plurality of printed fluorescent inks of different colours. In a particular embodiment, the printed marking comprises a background of a fluorescent ink of a first colour and a textual, numeric, graphic and/or other indicative marking printed on the background fluorescent ink.

In a particular embodiment, the display stand has at least one open-fronted compartment, preferably one having a forwardly facing basal face bounded by side faces of the compartment. In this embodiment, at least one of the basal face and/or at least one side face of the compartment is/are provided with a printed marking of a fluorescent ink, most preferably a plain or background, printed marking. The or each plain or background, printed marking preferably covers the respective face of the open fronted compartment. Preferably also the open-fronted compartment has at least one lip and the ultraviolet light source is provided behind the lip. With the basal face provided with printed fluorescent ink over its entire area and preferably at least one (and more preferably all) of the side faces also provided over its/their entire area with fluorescent ink the compartment provides an overall “illuminated” effect when the ultraviolet light source is activated. In addition to its plain or background coating of fluorescent ink the basal face and/or side face(s) may be provided with a textual, numeric, graphic or other indicative marking comprised of at least one colour of printed fluorescent ink.

In a second embodiment of the invention, the marking may comprise:
(a) one or more apertures in a face of the display stand,
(b) said fluorescent material provided as a background to said apertures, and
(c) at least one said source of ultra-violet light.

In such an arrangement, the apertures may be “cut-outs” which depict textual, numeric, graphic and/or other indicative markings. The fluorescent material is provided behind that face of the display stand in which the aperture(s) is/are provided so as to be visible therethrough. The source of ultraviolet light is provided behind that face of the display unit (in which the aperture(s) is/are provided) and the background fluorescent material. The positioning of the light source behind the wall ensures partial shielding thereof. Additionally, the light source, in conjunction with the background fluorescent material, provides an “illuminated” effect so that the indicative marking (formed by the apertures) itself appears to be illuminated.

It will be appreciated that the display stand may be provided with more than one marking, e.g. for example, some or all markings may be textual, numeric, graphic and/or other indicative markings in accordance with the first embodiment or some or all markings may be in accordance with the second embodiment. It will be further appreciated that each marking on the display stand may be provided with a respective source of ultra-violet light, preferably a strip of Light Emitting Diodes.

If desired, the display unit may be used to support a product or products having, on an outer surface thereof, a marking of a material that fluoresces in ultraviolet light, said product(s) being positioned on the unit so that its marking is illuminated by the ultraviolet light source. The product may be one having outer packaging printed with a marking (textual, numeric, graphic and/or other indicative marking) comprised of at least one fluorescent ink. The packaging may for example be paper, cardboard or other fibrous cellulosic material.

Display units in accordance with the invention may be associated with a control system controlling operation of the electrically operated source of ultra-violet light, wherein said control system comprises detection means for detecting the presence of a person in proximity to the display unit and a control unit operatively associated with the detection means and with the electrically operated source of ultra-violet radiation for controlling operation of said source in relation to the proximity of a person to the display unit.

In accordance with this embodiment, the source of ultra-violet light is switched-on (so as to irradiate the marking on the display stand and cause fluorescence of the marking) when a person is in proximity to the display unit. This provides a particularly advantageous effect since the person would initially only be aware of a “non-fluorescing” display unit (save for any fluorescence caused by “extraneous” ultra-violet radiation) but on approaching the sensor is immediately struck by the fluorescent effect caused by operation of the ultra-violet light source which is “switched on” by virtue of the proximity of that person. The electrically operated source of ultra-violet light may remain switched on for a predetermined period of time (e.g. under the control of a timer unit in the control system). Alternatively, the source of ultra-violet radiation may remain on so long as there is a person within proximity of the display unit.

The detection means may take various forms. It is particularly preferred that the detection means is a passive infra-red sensor but other detection means may be contemplated. Thus, for example, the detection means may comprise an electromagnetic beam (the breaking of which by a person in proximity to the display unit causes the source of ultra-violet radiation to be switched on).

The detection means may be mounted on the display unit or in proximity without actually being mounted on the unit.

It will be appreciated that control systems incorporating detection means as described are well known and may readily be adapted by the skilled person for use in the invention.

The display unit with associated control system may be positioned, for example, in the area of a store to which persons have access. Alternatively, the display unit with associated control system could be positioned in the window of a store, in which case the source of ultraviolet radiation is switched on by virtue of the presence of persons stood outside of the store whose attention is gained by virtue of the switching-on of the ultra-violet source and consequential fluorescence of the display stand.

It will be appreciated that the detection means may be readily “set-up” to provide for detection of a person only within a certain distance of the display unit.

Further features of the invention are defined in the appended claims.

The invention will now be further described by way of example only with reference to the accompanying drawings, in which:

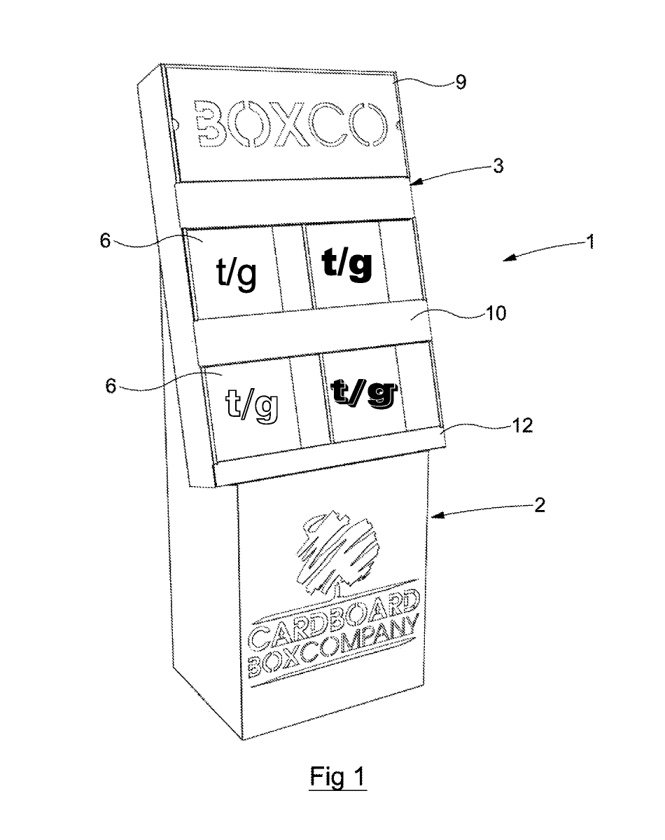

FIG. 1 is a perspective view of a first embodiment of display unit in accordance with the invention including a support stand and a display tray assembly on the stand;

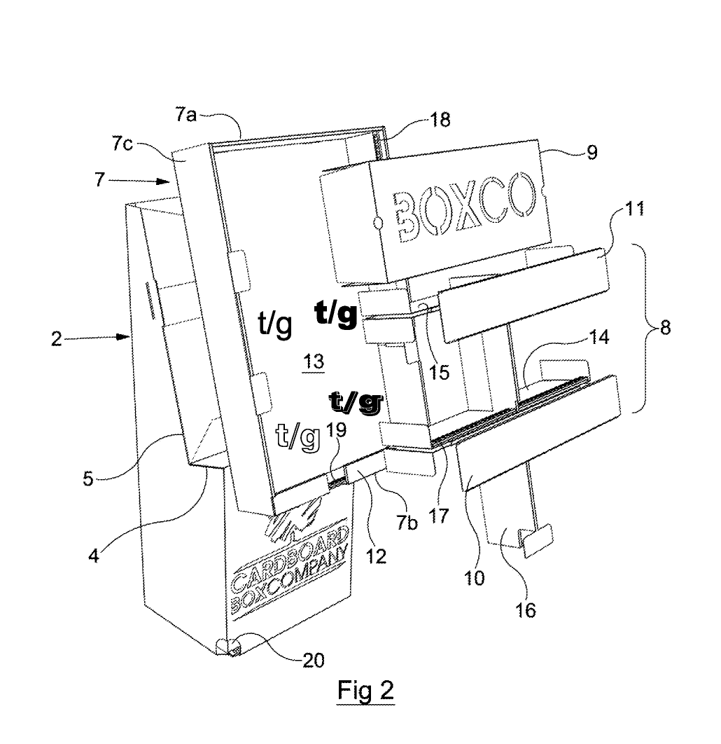

FIG. 2 is an exploded perspective view of the display unit shown in FIG. 1 but as a “line drawing”;

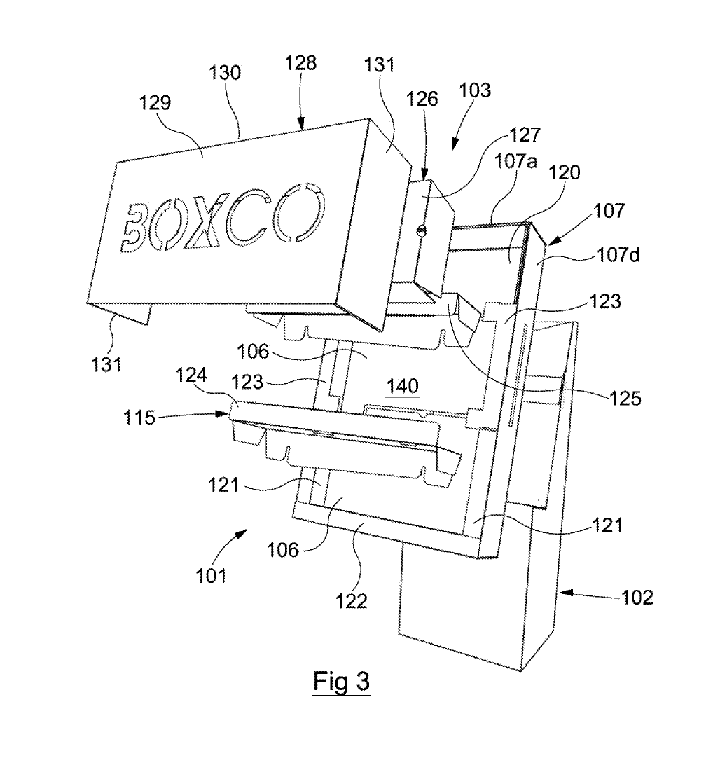

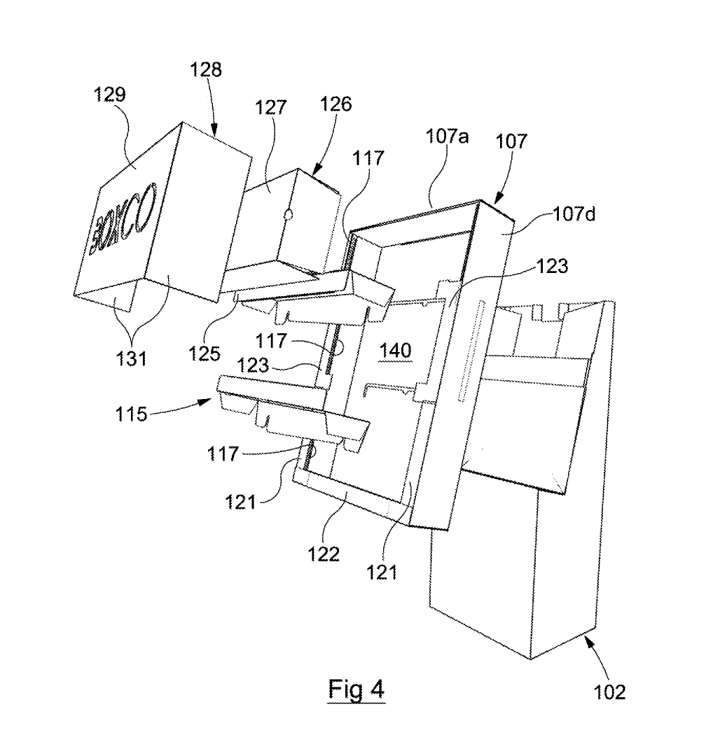

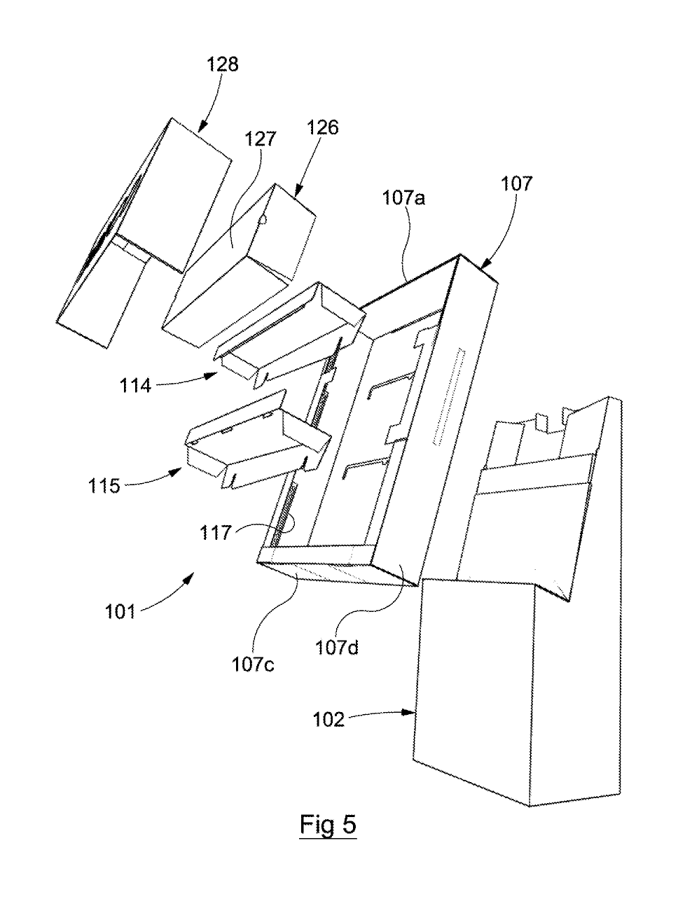

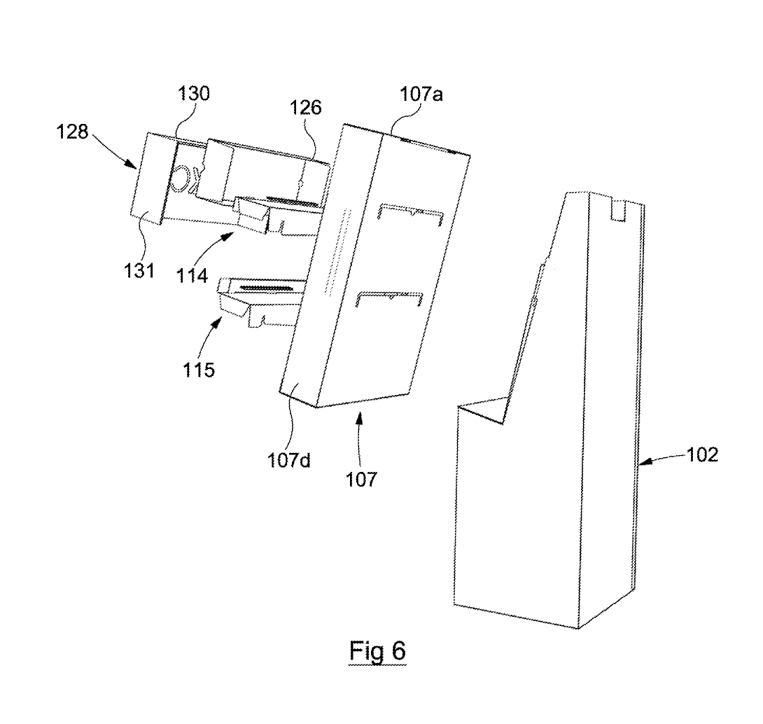

FIGS. 3 to 6 are exploded views, from different angles, of a second embodiment of display unit in accordance with the invention; and

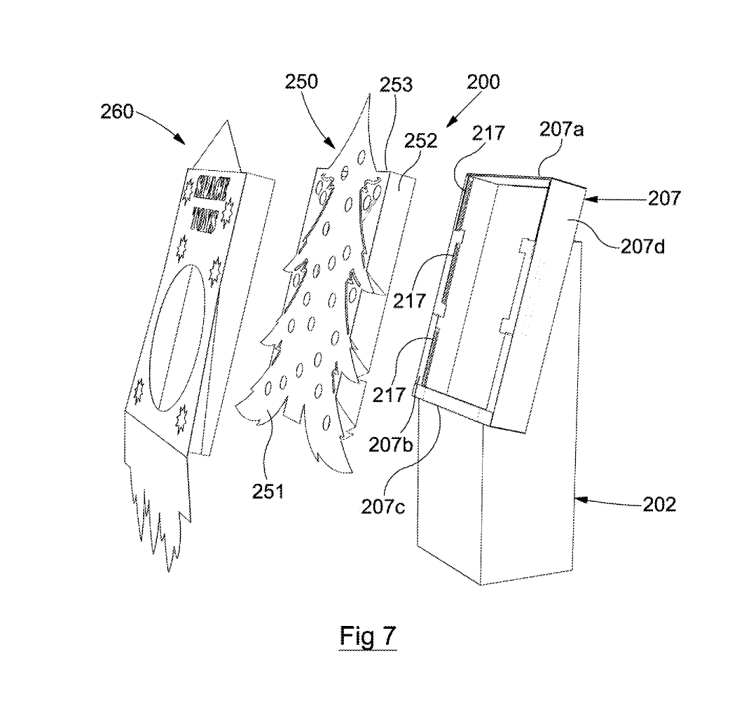

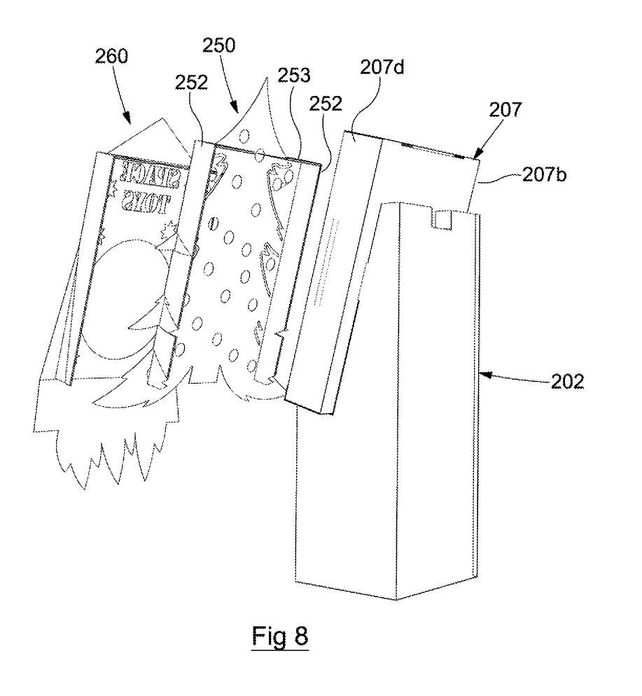

FIGS. 7 and 8 are exploded views, from different angels, of a third embodiment of display unit in accordance with the invention.

As illustrated in the drawings, a display unit 1 in accordance with the invention (i.e. one having provision for fluorescent display) is formed principally of cardboard and includes a base stand 2 and a rectangular display tray assembly 3 (see particularly FIG. 2) which is supported by its lower edge on a frontal ledge 4 of stand 2 and lying against support edges 5 (of stand 2) inclined upwardly and rearwardly away from the ledge 4.

The display stand 1 has various fluorescent display areas in which (as described more fully below) fluorescent ink is illuminated by Light Emitting Diodes provided on the display unit 1 so as to provide a visually striking appearance for the display unit. In the illustrated strand 1, these display areas include “BOX CO” in the upper region of the tray assembly 3, textual/graphical markings (represented for convenience in the drawings as “t/g”) provided on the rear surfaces of compartments 6 formed in the tray assembly 3, and the words “CARDBOARD BOX COMPANY” and associated logo on a frontal surface of base stand 2. The textual/graphical markings “t/g” may, for example, be in the form of one or more of letters, numbers, drawings or other characters which for example represent the nature of the product being displayed on the unit. The markings, may, for example, be Trade Marks, logos, pictorial representations of product etc. As shown in FIGS. 1 and 2, there are four markings “t/g” and it will be appreciated that these may all be the same but may also be different both in terms of indicative information and/or colour.

The manner in which these fluorescent displays (each of which comprises areas of fluorescent ink irradiated by Light Emitting Diodes) function will be given below, subsequent to the following more detailed description of the structure of the display unit

As mentioned above, display unit 1 includes tray assembly 3 which incorporates a number of fluorescent display areas. This tray assembly comprises a shallow tray 7 (see FIG. 2), a divider arrangement 8, a header unit 9, and fascia elements 10 and 11. For convenience, tray 7 is shown as having upper and lower sides 7a and 7b respectively, and left and right sides 7c and 7d respectively. Lower side 7b of tray 7 is formed with a lip 12 which partially overlies the floor of tray 7.

For the reasons that will be appreciated from the description below, the full area of the floor of tray 7 is marked or otherwise provided over its entire area with fluorescent ink, represented by reference numeral 13. This ink 13 may be printed on the floor of the tray or may be printed on an insert (e.g. paper) which is affixed to the floor of the tray.

As shown in the drawings, divider arrangement 8 has two parallel lower and upper arms 14 and 15 which are bisected at right angles by a spine 16 of the divider unit 8. The divider unit 8 locates in the shallow tray 7 so as to define the aforementioned four open-fronted compartments 6, with lower arms 14 defining shelves for the upper compartment 6 and the upper arms 15 defining one boundary of a headspace in which header unit 9 locates. Fascia elements 10 and 11 are positioned over the outer edges of arms 14 and 15 respectively and define upper and lower lips for the compartments 6.

The side faces of the compartment 6 are preferably also printed with a plain coating of fluorescent ink, e.g. of the same colour as ink 13 (although a contrasting colour may be used).

It should at this point be appreciated that the positioning of the markings “t/g” on the floor of shallow tray 7 is such that they are visible when viewed from the front of compartments 6.

The fluorescent inks used for providing the coating 13 and the textual/graphical markings “t/g” may, for example, be water-based fluorescent inks. Suitable inks are the HGA code range of water based fluorescent inks available from Flint Group.

Header unit 9 is open at its rear side (i.e. the side adjacent ink coating 13) but is otherwise of generally box-like construction, as clearly seen in FIG. 2. The front face of header unit 9 is formed with cut-outs configured to define stylised lettering (shown in the figures as “BOX CO”). In view of the “cut-out” nature of this lettering, it will be appreciated that the coating of fluorescent ink 13 on the floor of tray 7 is visible through the lettering.

Display tray assembly 3 further incorporates a number of strips of Light Emitting Diodes (LEDs) 17-19 in which, in any one strip, the LEDs are electrically connected together so that all LED's in a strip may be simultaneously illuminated. The LED's are of a type which emit ultra-violet light, although may also emit visible light at or towards the violet end of the spectrum. UV Gear (a division of Mark SG Enterprises; www.uvgearco.uk) under the product codes UV998A LED and UV998B LED, both being in the form of 5 meter strips of LED and comprising 30 LEDs and 60 LEDs per meter.

In relation to the construction of the display unit, LED strips 17 are provided on the upper surface of lower arm 13, immediately behind fascia 10. LED strips 18 are provided on the inner surfaces of the sides 7c and 7d of the tray 7 towards the upper ends thereof (only the LED strips provided on side 7d being visible in the drawing). Finally, LED strip 19 is provided on the inner surface of side 7b of tray 7, immediately behind the lip 12.

Similarly to the header unit 9, the front lower face of stand 2 is also formed with stylised lettering formed as “cut-outs” (in this case the lettering reading “CARDBOARD BOX COMPANY”). As shown in the cut-away portion of FIG. 2, there is a panel 20 which is plain coated with a fluorescent ink (e.g. of the same type described above) positioned within the stand a short distance behind (and parallel to) the front face of the stand. Between this front face and the ink-coated panel is a further strip of LEDs (not illustrated).

All strips of LEDs may be linked together to run from a common power-source. This may, for example, be a battery provided on the unit or a transformer plug connected to mains electricity.

When the LEDs are illuminated, the display stand provides a number of striking effects derives from the illumination of the fluorescent areas by the LEDs, the effects being enhanced by the fact that all of the LED strips are shielded, to a greater or lesser extent, from extraneous light. Thus, for example, the strips 17 and 19 are shielded by the fascia 11 and the lip 12 respectively, and strip 18 is shielded by the structure of the header unit 9. As a result of this shielding, the LEDs are used to their “maximum effect”.

In more detail, the LED strips 17 and 19 cause fluorescence of the back walls of compartments 6, thus providing for fluorescence not only of the fluorescent ink coating 13 provided over the floor of the tray 7 but also fluorescence of the markings “t/g” and give the compartments 6 an overall illuminated “coloured” appearance. Secondly, the LED strips 18 illuminate the fluorescent ink coating 13 behind the letters “BOX CO” formed in the header unit 9 and give the appearance of these letters being at the front of, and illuminated by, a “lit chamber” behind the front face of header unit 10. Operation of the LED strips (not shown) associated with the lettering “CARDBOARD BOX COMPANY”, formed in the front face of the based stand 2 similarly provides the appearance of these letters being at the front of, and illuminated by, a “lit chamber”.

In a modification of the display unit shown in FIGS. 1 and 2, the background coating 13 of fluorescent ink on the floor of tray 7 may be provided only in the region of header unit 9 without extending onto the rear faces of compartments 6. Each such compartment may then have its own “background layer” of fluorescent ink (on which markings of contrasting colour may be provided), or no such background at all.

Reference is now made to FIGS. 3 to 6 of the accompanying drawings which show exploded views, from various angles, of a further embodiment of display unit 101 in accordance with the invention. Display unit 101 is of somewhat similar construction to display unit 1 shown in (and described with reference to) FIGS. 1 and 2 of the drawings and comprises a base stand 102 supporting an inclined display tray assembly 103 constructed with shallow tray 107 shown as having sides 107a-107d. Tray assembly 103 incorporates upper and lower, separate shelf units 114 and 115 respectively which (unlike the shelves 14 and 15 of the embodiment of FIGS. 1 and 2) are mounted onto the tray 107 by “slot-and-tab” arrangements rather than being mounted on a central spine. Shelf units 114 and 115 sub-divide tray 107 into two upper and lower, open-fronted compartments 106 and further into a headspace 120. As will be appreciated from the drawings, each of the two compartments 106 has frontal, peripheral lips 121 to 125. In the case of lower compartment 106, the lips are provided by two flanges 121 projecting inwardly from opposed longitudinal edges of the tray 107, and a lower flange 122 provided on the lower widthwise edge of tray 7. In the case of upper compartment 106, the lips are provided by two flanges 123 projecting inwardly from opposed longitudinal edges of tray 107, a lower upstanding flange 124 provided at the front of lower shelf 115 and an upper depending flange 125 provided at the front of upper shelf 114.

The area of the floor of tray 107 may be printed over its entire area with a fluorescent ink, as represented by reference numeral 140. Alternatively, the floor of tray 107 may be provided with the ink 140 only over the area of the compartments 106. Ideally, the inner surfaces of sides 107a-d of tray 107 are also printed with fluorescent ink 140.

Located within headspace 120 and seated on upper shelf 114 is a generally box-like structure 126 which is open at its rear face and which has a rectangular frontal surface 127. The peripheral sides of box-like structure 126 are dimensioned so as to have a height (i.e. the distance between the frontal surface 127 and open rear face of the box-like structure 126) which is less than that of the sides 107a-d of the tray 107. As such, the box-like structure 126 may be seated in the headspace 120 such that frontal surface 127 (of the box-like structure 126) located below the level of the rim of tray 107. Frontal surface 127 is printed over its entire area with a single colour of fluorescent ink.

LED strips 117 are located on the inner surfaces of the longitudinal sides 107b and 107d of tray 107, more particularly, behind each of the two flanges 121, behind each of the two flanges 123, and also in the region of the headspace 120 just below the rim of tray 107. The positioning of the LED strips in the region of the headspace 120 is such that, with the box-like structure 126 fully seated in position, these LED strips 117 are located between the front, fluorescent surface (of box-like structure 126) and the rim of tray 107.

The display unit 101 is completed by a header unit 128 which comprises a front face 129, an upper side 130 and two side faces 131. Front face 129 of header unit 128 is formed with apertures defining lettering (in this case “BOX CO”). Header unit 128 sits on the upper side 107a of tray 107 so that the front face 129 (of unit 128) locates in front of the (fluorescent) rectangular face 127 of box-like structure 126. It will be appreciated that, with header unit 128 seated on the tray 107, the upper face 130 (of header unit 128) seats on the upper side of tray 107a and the side faces locate over (i.e. externally of) the upper regions of the longitudinal sides 107b and 107d of tray 107. As such, header unit is easily positioned on, and removable from, tray 107.

A further point to be noted is that the base stand 102 is “plain” in the sense that it is not formed with any lettering, graphics or other indicia that would relate to, and identify, a particular product or retail or other outlet.

The display unit 101 provides fluorescent effects in exactly the same way as described above for the display unit 1 shown in FIGS. 1 and 2.

Display unit 101 is however structured so that (as compared to the display unit 1 shown in FIGS. 1 and 2) it is more convenient (a) for the purposes of manufacture and supply to a range of customers (e.g. retailers with different names), and (b) for a purchaser of the unit to make a certain number of changes so as periodically to alter the appearance of the unit. More particularly, as far as the manufacturer is concerned, all of the described components of display unit 101 with the exception of the header unit 128 may be used for producing display stands for the manufacturers different customers since there is no information on any of these components that identifies a particular product, retail outlet etc. Nevertheless, the manufacturer is able readily to produce header units 128 with different lettering as required by different purchasers of the display unit. Furthermore, the illustrated unit is also versatile from the point of view of the purchaser of the unit. Two points are relevant here. The first is that the purchaser may use the display unit for a certain period of time to display a particular product identified by the appropriate lettering on header unit 128. Subsequently, the purchaser of the unit may decide to use that unit to display a different product, in which case it is only necessary to replace the existing header unit 128 by one having lettering appropriate to the new product to be displayed. Furthermore, and if desired, the box-like unit 126 may be replaced by one having a frontal surface 127 printed with a different colour fluorescent ink. For this purpose, box-like unit 126 is formed with apertures 150 into which a finger may be inserted to assist withdrawal of box-like unit 126 from headspace 120.

In a modification of the display unit 101 illustrated in FIGS. 3 to 6 of the drawings, the box-like unit 126 may be provided but have a plain frontal face 127 (i.e. one that is not printed with a fluorescent ink). In this case, a separate, rectangular piece of card (ideally having the same dimensions of frontal face 127) printed on one surface with a fluorescent ink may be positioned in the headspace 120 with its fluorescent face forward. In this case, the printed card serves the purposes of a fluorescent face 127 of box-like structure 126 and may readily be replaced by one of different colour when desired.

A further embodiment of the invention is illustrated in FIGS. 7 and 8 of the accompanying drawings. Illustrated in FIGS. 7 and 8 is a display unit 200 which is intended to be used solely for promotional purposes, rather than displaying products that may be selected from the unit by a consumer. Display unit 200 comprises a base stand 202 supporting an inclined tray 207 on which is removably mounted either a promotional element 250 or a promotional element 260.

Tray 207 is shown as having sides 207a-d and is provided along the inner surfaces of each of its longitudinal sides 207b and 207d with LED strips 217.

Promotional element 250 has a front face 251, two longitudinal sides 252 and an upper side 253. The spacing between the inner surfaces of the longitudinal sides 252 is marginally greater than the spacing between the outer surfaces of longitudinal sides 207b and 207d of tray 207. It will therefore be appreciated that promotional element 250 removably seats on tray 207 with the upper side 253 (of promotional element 252) locating above sides 207a of tray 207 and with the sides 252 of promotional element 250 locating along the outer faces of longitudinal sides 207b and 207d of tray 207. Promotional element 250 is shown as having its front face 251 formed with the appearance of a “Christmas tree” and further formed with apertures 254 representing decorations (e.g. “baubles”) on such a Christmas tree. With promotional element 250 located in position and LED strips 217 illuminated, the display unit 200 has an “inner glow” provided by the fluorescent ink on the inner surfaces of the tray 207. Externally, the apertures 244 give the appearance of illuminated decorations on a Christmas tree.

Promotional element 250 may, when necessary or desired, be replaced by promotional element 260 which is provided with apertures defining lettering (in this case “ TOYS”) and further apertures for providing a purely decorative effect, one of these being a major, circular aperture in the front face of promotional element 260 and others being in the form of somewhat smaller “starts”.

In a development of the invention, a display unit such as that illustrated in FIGS. 1 and 2 or FIGS. 3-6 of the drawings may be used to support and display products (e.g. on a shelf of the stand) which themselves have a marking of a fluorescent ink on the packaging of the article. Such products may for example comprise paper or cardboard packaging to which a printed marking of fluorescent ink has been applied. In a manner entirely analogous to that described above, the LED strips illuminate the packaging and cause the ink provided thereon to fluoresce and given an illuminated appearance to at least a portion of the packaging. It will be appreciated that, for this embodiment of the invention, fluorescent ink on the packaging and fluorescent ink on the display unit (e.g. on the rear or side walls of the compartments or floor thereof can be selected for their combined aesthetic effect.

It will be appreciated that a number of modifications may be made to the above-described embodiments. Thus, for example, the display unit may be of a somewhat different structure from that illustrated, but nevertheless still embody the principle of the use of fluorescent inks that underlie the invention. Furthermore, whilst the use of LED strips provide a preferred source of ultra-violet illumination for illuminating the fluorescent inks on the display unit, other ultra-violet sources could be used. Such sources would, most conveniently, be provided on the display unit but it is also within the ambit of the invention to provide an ultra-violet source which is external to the display unit. Such a source could, for example, be in the form of a spot light positioned to shine onto a support (e.g. shelf or compartment) of a display unit, which support is either provided with markings of a fluorescent ink or supports a product for which the packaging is provided with a marking of such an ink.

It will be appreciated that all of the embodiments of the invention described with reference to FIGS. 1-8 above may be associated with a control system including detection means for detecting the presence of a person in proximity to the display stand and a control unit operatively associated with the detection means and with the electrically operated light emitting diode for controlling operation of the diodes on detection of a person in proximity to the display unit, as described more fully above.

What is claimed:

1. A display unit comprising a display stand having at least one marking comprised of a material that fluoresces when irradiated with ultra-violet light, and an electrically operated source of ultra-violet light for irradiating said marking to cause fluorescence thereof.

2. A display unit as claimed in claim 1 wherein the display stand is constructed of cardboard.

3. A display unit as claimed in claim 1 wherein said source of ultra-violet light is located on the display stand.

4. A display unit as claimed in claim 3 wherein said source of ultra-violet light is partially shielded from extraneous light.

5. A display unit as claimed in claim 1 wherein said source of ultra-violet light comprises at least one Light Emitting Diode

6. A display unit as claimed in claim 5 wherein said source of ultra-violet light comprises a plurality of said Light Emitting Diodes electrically connected together.

7. A display unit as claimed in claim 6 wherein said plurality of Light Emitting Diodes comprises at least one integral strip of Light Emitting Diodes.

8. A display unit as claimed in claim 1 wherein said marking is, or includes, a printed marking of at least one fluorescent ink on a surface of the display stand.

9. A display unit as claimed in claim 8 wherein the printed marking is of a plain colour.

10. A display unit as claimed in claim 8 wherein said printed marking comprises a plurality of printed fluorescent inks of different colours.

11. A display unit as claimed in claim 8 wherein the printed marking comprises a plain background of a fluorescent ink of a first colour and a textual, numeric, graphic and/or other indicative marking printed on the background and comprised of at least one fluorescent ink of different colour to said first colour.

12. A display unit as claimed in claim 1 wherein said display stand has at least one open-fronted compartment.

13. A display unit as claimed in claim 12 wherein the compartment has a forwardly facing basal face bounded by side faces of the compartment and at least one of the basal face and/or at least one of the side faces of the compartment is/are provided with a printed marking of a fluorescent ink.

14. A display unit as claimed in claim 13 wherein said printed marking on the basal face and/or side face(s) of the compartment is a plain or background, printed marking of a fluorescent ink and covers the respective face of the open-fronted compartment.

15. A display unit as claimed in claim 12 wherein said compartment has a frontal lip and a said source of ultra-violet light for illuminating said marking is provided behind the lip.

16. A display unit as claimed in claim 1 incorporating a marking which comprises
(a) one or more apertures in a face of the display stand,
(b) said fluorescent material provided as a background to said aperture(s), and
(c) at least one said source of ultra-violet light
wherein said background fluorescent material is provided behind said face and is visible through said at least one aperture, and said at least one source of ultra-violet light is provided between said wall of the display unit and said fluorescent material.

17. A display unit as claimed in claim 16 wherein said apertured face is removable from the display stand.

18. A display unit as claimed in claim 16 wherein said background fluorescent material is removably positioned in the display stand.

19. A display unit as claimed in claim 1 comprising a base stand and a tray assembly supported on the stand, said tray assembly having an open top and being supported so that said open top is forwardly facing.

20. A display unit as claimed in claim 1 removably supporting a product having, on an outer surface thereof, a marking of a material that fluoresces in ultra-violet light, said product being positioned on the unit so that its marking is illuminated by a said source of ultra-violet light.

21. A display unit as claimed in claim 20 wherein said product comprises outer packaging and the marking on the product comprises at least one fluorescent ink printed onto the packaging.

22. A display unit as claimed in claim 21 wherein said packaging is of paper, cardboard or other fibrous cellulosic material.

23. A display unit as claimed in claim 1 in combination with a control system controlling operation of the electrically operated source of ultra-violet light, wherein said control system comprises detection means for detecting the presence of a person in proximity to the display unit and a control unit operatively associated with the detection means and with the electrically operated source of ultra-violet radiation for controlling operation of said source in relation to the proximity of a person to the display unit.

24. A display unit as claimed in claim 23 wherein the control system is adapted to switch on the source of ultra-violet light on detection of a person in proximity to the display unit.

25. A display unit as claimed in claim 24 wherein the control system is adapted to switch off the source of ultra-violet light after a predetermined time.

26. A display unit as claimed in claim 23 wherein the detection means is mounted on the display unit.

27. A display unit as claimed in claim 23 wherein the detection means is located otherwise than on the display unit but in proximity thereto.

28. A display unit as claimed in claim 23 wherein the detection means comprises a passive infra-red sensor.
